(19) United States
(12) Patent Application Publication
(10) Pub. No.: US 2022/0383402 A1
(43) Pub. Date: Dec. 1, 2022

(54) BATTERY MANAGEMENT SYSTEM AND BATTERY MANAGEMENT METHOD

(71) Applicant: PANASONIC INTELLECTUAL PROPERTY MANAGEMENT CO., LTD., Osaka (JP)

(72) Inventors: Masashi TAKEMURA, Kanagawa (JP); Kenichiro SHIBASAKI, Kanagawa (JP); Kiyoshi NAKANISHI, Kanagawa (JP); Toshiya ZAITSU, Tokyo (JP); Ryota SAITO, Kanagawa (JP)

(73) Assignee: PANASONIC INTELLECTUAL PROPERTY MANAGEMENT CO., LTD., Osaka (JP)

(21) Appl. No.: 17/775,826

(22) PCT Filed: Sep. 17, 2020
(86) PCT No.: PCT/JP2020/035213

§ 371 Date: May 10, 2022

(30) Foreign Application Priority Data
Nov. 11, 2019 (JP) 2019-204226

(51) Int. Cl. G06Q 30/06; G06F 21/32

(52) U.S. Cl. CPC G06Q 30/0645; G06F 21/32; B60L 53/80

(57) ABSTRACT

The present application includes: battery packs; a battery exchanger for storing and charging the battery packs and renting the charged battery packs to users; a management server for managing battery exchange at the battery exchanger; and a registration machine for acquiring face images for registration used in face authentication of the users. The registration machine acquires the face images for registration and specific information which is information other than the face images and is used to specify the users, and the management server acquires the specific information of each user from the registration machine to perform user management, compares a face image for authentication acquired from a captured image of a person who has visited for battery exchange with the face images for registration to face match to determine whether the person is a legitimate user, and determines whether the battery exchange is permitted based on the face matching.

### TECHNICAL FIELD

The present disclosure relates to a battery management system and a battery management method for managing exchange of battery devices by users in a battery exchange service in which users of electric vehicles or the like exchange battery devices at battery stations.

### BACKGROUND ART

In recent years, electric vehicles such as electric motorcycles have attracted attention from the viewpoint of solving the problems of air pollution due to exhaust gas and high fuel costs. The cruising ranges of such electric vehicles are progressively extended owing to the improvement in the performance of battery devices, but such electric vehicles may cause inconvenience since they cannot travel continuously for a long time due to the necessity for charging the battery devices.

In order to eliminate such inconvenience, a battery exchange service is becoming popular, which enables the electric vehicles to travel continuously for a long time by fitting the electric vehicles with detachable battery devices so that exhausted battery devices can be exchanged with fully charged battery devices at battery stations.

Regarding such a battery exchange service, there is conventionally known a technology in which user authentication is executed when battery exchange is performed so that the battery exchange is limited to preregistered persons (see Patent Document 1). In this technology, at the time of user registration, the identification information of the electric vehicle used by the user is registered; when the battery device is fitted to the electric vehicle, the identification information of the electric vehicle (specific information) is stored in the battery; at a battery exchange device (management device), the identification information of the electric vehicle is acquired from the returned battery device; and based on the identification information of the electric vehicle, it is determined whether the person who returned the battery device is a legitimate user.

### PRIOR ART DOCUMENT(S)

### Patent Document(s)

[Patent Document 1] JP6322744B1

### SUMMARY OF THE INVENTION

### Task to be Accomplished by the Invention

Incidentally, in the case of an electric vehicle fitted with two battery devices for example, to exchange the two battery devices, the two battery devices removed from the electric vehicle are held by the both hands of the user to be brought into the battery exchange device, and at this time, since the both hands of the user are occupied, it is desired that the user authentication be performed without the user being required to perform a special operation.

Regarding such a demand, in the conventional technology, the user authentication is performed by only returning the battery device to the battery exchange device, and therefore, the user does not have to perform any special operation and the user's labor at the time of battery exchange can be reduced.

However, the conventional technology only determines whether the vehicle fitted with the battery devices is a preregistered legitimate vehicle based on the identification information of the vehicle, and does not determine whether the person who actually performs battery exchange is a legitimate user. Therefore, if the electric vehicle is a preregistered one, the person can perform battery exchange even if the person is not a legitimate user. Therefore, from the viewpoint of security, the conventional technology is not sufficient.

In view of the above, a primary object of the present disclosure is to provide a battery management system and a battery management method which can reduce the user's labor at the time of battery exchange and can sufficiently ensure security regarding the user authentication.

### Means to Accomplish the Task

A battery management system of the present disclosure is a battery management system, comprising: multiple battery devices shared in a battery exchange service; a battery exchange device configured to store and charge the battery devices and to rent the charged battery devices to users; a server device connected to the battery exchange device via a network and configured to manage battery exchange at the battery exchange device; and a registration device configured to acquire face images for registration used in face authentication of the users, wherein the registration device acquires the face images for registration and specific information which is information other than the face images and is used to specify the users, and the server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.

Also, a battery management method of the present disclosure is a battery management method for managing exchange of battery devices by users in a battery management system comprising a battery exchange device configured to store and charge the battery devices and to rent the charged battery devices to the users, wherein: a registration device acquires face images for registration used in face authentication of the users and specific information which is information other than the face images and is used to specify the users; and a server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.

### Effect of the Invention

According to the present disclosure, since the face matching is performed as the user authentication, the user does not have to perform any special operation and thus the user's labor at the time of battery exchange can be reduced, while it is possible to ensure sufficient security regarding the user authentication. Further, since the specific information is acquired at the registration device besides the face images for registration, it is possible to perform user management at the server device by associating the face images for registration with the specific information, and therefore, the user management can be performed properly and efficiently.

### BRIEF DESCRIPTION OF THE DRAWINGS

FIG. 1 is an overall configuration diagram of a battery sharing system according to the first embodiment;

FIG. 2 is a block diagram showing a schematic configuration of a registration machine 5 regarding the first embodiment;

FIG. 3 is a block diagram showing a schematic configuration of a battery exchanger 3 regarding the first embodiment;

FIG. 4 is a block diagram showing s schematic configuration of a management server 4 regarding the first embodiment;

FIG. 5 is an explanatory diagram showing an outline of a process performed by the registration machine 5 and the management server 4 regarding the first embodiment at the time of user registration;

FIG. 6 is an explanatory diagram showing a screen displayed on a display 13 of the registration machine 5 regarding the first embodiment at the time of user registration;

FIG. 7 is a flowchart showing an operating procedure of the registration machine 5 and the management server 4 regarding the first embodiment at the time of user registration;

FIG. 8 is an explanatory diagram showing an outline of a process performed by the battery exchanger 3 and the management server 4 regarding the first embodiment at the time of battery exchange;

FIG. 9 is a flowchart showing an operating procedure of the battery exchanger 3 and the management server 4 regarding the first embodiment at the time of battery exchange;

FIG. 10 is an explanatory diagram showing a screen displayed on a display 36 of the battery exchanger 3 regarding the first embodiment at the time of battery exchange;

FIG. 11 is a block diagram showing a schematic configuration of the battery exchanger 3 and a face authentication machine 8 regarding the second embodiment;

FIG. 12 is a flowchart showing an operating procedure of the battery exchanger 3 and the management server 4 regarding the third embodiment at the time of battery exchange;

FIG. 13 is a flowchart showing an operating procedure of the battery exchanger 3 and the management server 4 regarding the third embodiment at the time of battery exchange;

FIG. 14 is an explanatory diagram showing an outline of a process performed by the registration machine 5 and the management server 4 regarding the fourth embodiment at the time of user registration;

FIG. 15 is an explanatory diagram showing an outline of a process performed by the registration machine 5 and the management server 4 regarding the fifth embodiment at the time of user registration; and

FIG. 16 is an explanatory diagram showing an outline of a process performed by the registration machine 5 and the management server 4 regarding the sixth embodiment at the time of user registration.

### MODE(S) FOR CARRYING OUT THE INVENTION

A first aspect of the invention made to solve the above problem is a battery management system, comprising: multiple battery devices shared in a battery exchange service; a battery exchange device configured to store and charge the battery devices and to rent the charged battery devices to users; a server device connected to the battery exchange device via a network and configured to manage battery exchange at the battery exchange device; and a registration device configured to acquire face images for registration used in face authentication of the users, wherein the registration device acquires the face images for registration and specific information which is information other than the face images and is used to specify the users, and the server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.

According to this, since the face matching is performed as the user authentication, the user does not have to perform any special operation and thus the user's labor at the time of battery exchange can be reduced, while it is possible to ensure sufficient security regarding the user authentication. Further, since the specific information is acquired at the registration device beside the face images for registration, it is possible to perform user management at the server device by associating the face images for registration with the specific information, and therefore, the user management can be performed properly and efficiently.

In a second aspect of the invention, the battery exchange device is provided with a camera for capturing an image of the person who has visited for battery exchange, and the face image for authentication is acquired from an image captured by the camera.

According to this, since the battery exchange device is provided with a camera, the user can efficiently perform an action of standing in front of the camera for image capture and an action of exchanging the battery devices.

In a third aspect of the invention, the registration device acquires the specific information from personal identification cards presented by the users.

According to this, it is possible to eliminate the labor for inputting the specific information of the target person.

In a fourth aspect of the invention, the personal identification cards are each an IC card, and the registration device acquires information stored in the personal identification cards as the specific information.

According to this, it is possible to efficiently acquire the specific information of the target person.

In a fifth aspect of the invention, the registration device acquires the face images for registration from personal identification cards presented by the users.

According to this, it is possible to eliminate the labor for capturing an image of the face of the target person with the camera.

In a sixth aspect of the invention, the personal identification cards are each an IC card, and the registration device acquires face images stored in the personal identification cards as the face images for registration.

According to this, it is possible to efficiently acquire the face image of the target person.

In a seventh aspect of the invention, each personal identification card is either a driver's license or a membership card of the battery exchange service.

According to this, since the driver's license or the membership card of the battery exchange service is usually carried by the person driving the electric vehicle, it is possible to eliminate the labor for making special preparation for user registration.

In an eighth aspect of the invention, the battery exchange device has a shutter at an opening for putting in and out the battery devices, and controls opening and closing of the shutter according to a result of determination by the server device on whether to permit the battery exchange.

According to this, when the person who has visited for battery exchange is not a legitimate user, it is possible to reject return of the battery devices brought in by the person or rental of charged battery devices.

A ninth aspect of the invention is a battery management method for managing exchange of battery devices by users in a battery management system comprising a battery exchange device configured to store and charge the battery devices and to rent the charged battery devices to the users, wherein: a registration device acquires face images for registration used in face authentication of the users and specific information which is information other than the face images and is used to specify the users; and a server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.

According to this, as in the first aspect of the invention, the user's labor at the time of battery exchange can be reduced and sufficient security regarding the user authentication can be ensured. Further, the user management can be performed properly and efficiently.

In the following, embodiments of the present disclosure will be described with reference to the appended drawings.

### First Embodiment

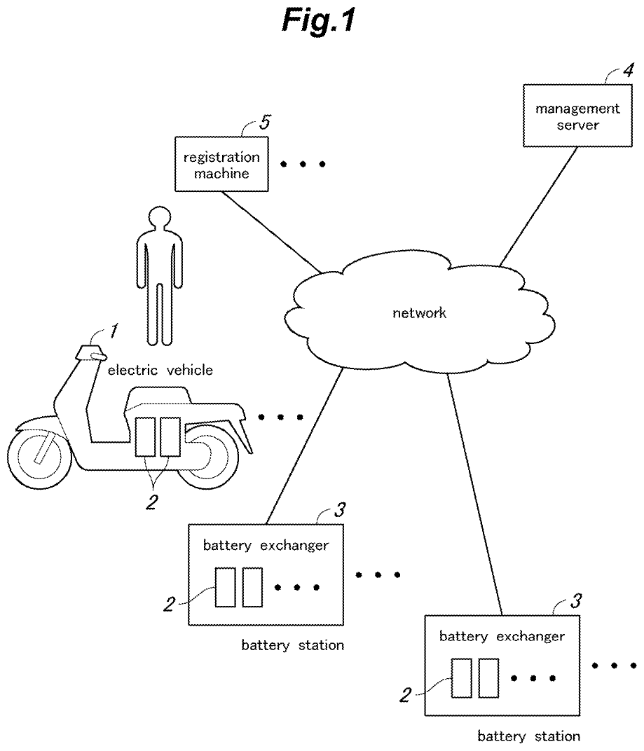

FIG. 1 is an overall configuration diagram of a battery sharing system according to the first embodiment.

This battery sharing system (battery management system) is configured to provide a service (battery exchange service) in which battery packs 2 (battery devices) fitted to electric vehicles 1 such as electric motorcycles can be shared among a plurality of users, and includes battery exchangers 3 (battery exchange devices), a management server 4 (server device), and registration machines 5 (registration devices).

The battery exchangers 3, the management server 4, and the registration machines 5 are connected via a network such as the Internet. Note that the battery exchangers 3 are connected to the network via a wireless communication such as a mobile communication network and a wireless LAN.

Each electric vehicle 1 is fitted with the battery packs 2, and travels on the electric power of the battery packs 2. The electric vehicle 1 consists of an electric motorcycle in the example shown in FIG. 1, but may also consist of a four-wheeled vehicle. Further, the electric vehicle 1 may be a mobility device not designed for public roads such as an electric wheelchair, an electric cart, or a riding cart for use in a theme park, a golf course, or the like.

Each battery exchanger 3 stores and charges the battery packs 2 returned by the users, and rents the charged battery packs 2 to the users in exchange for the returned battery packs 2. The battery exchangers 3 are installed in battery stations attached to facilities (stores) such as convenience stores and gas stations. A plurality of battery exchangers 3 are installed in each one of the battery stations.

The management server 4 registers and manages persons who subscribe to the battery exchange service and use the battery packs 2 as users (members) (user management). Also, the management server 4 registers and manages the battery packs 2 shared in the battery exchange service (battery management).

Each registration machine 5 is operated by the target person her/himself or a staff member to perform user registration.

The battery packs 2 to be fitted to electric vehicles 1 are given as an example in the present embodiment, but battery devices to which the battery packs 2 are fitted are not limited to the electric vehicles 1, and may be portable power supply devices, for example.

Also, in the present embodiment, the management server 4 has two functions of face authentication and battery management, but the functions of the management server 4 may be separately performed by a face authentication server that performs the process related to face authentication and a battery management server the performs the process related to battery management. Further, the functions of the face authentication server may be separately performed by a face management server that centrally manages the user information (face image, specific information, etc.) and a face matching server that performs a face matching process.

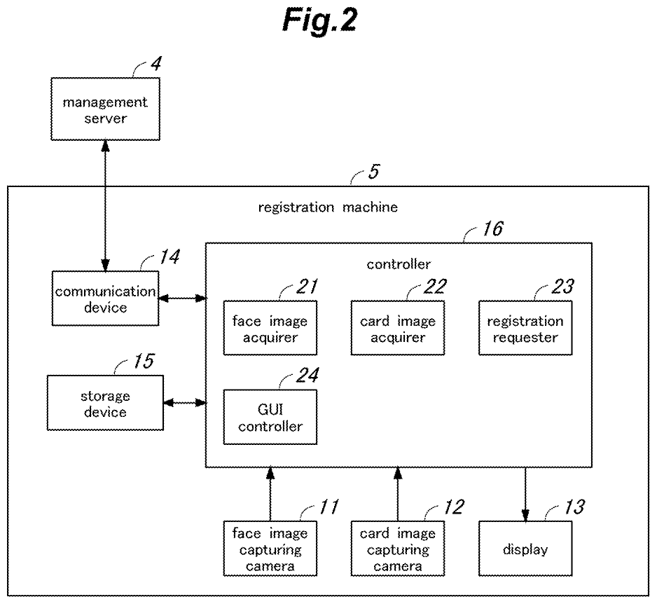

Next, description will be made of a schematic configuration of the registration machine 5 regarding the first embodiment. FIG. 2 is a block diagram showing a schematic configuration of the registration machine 5.

The registration machine 5 includes a face image capturing camera 11, a card image capturing camera 12, a display 13, a communication device 14, a storage device 15, and a controller 16.

The face image capturing camera 11 captures an image of the face of the target person at the time of user registration.

The card image capturing camera 12 captures an image of a face of a personal identification card presented by the target person, specifically, the driver's license, the membership card (member's card) of the battery exchange service, etc.

The display 13 displays a screen related to user registration. Note that this display 13 is constituted of a touch panel, and the target person her/himself or a staff member can perform screen operation.

The communication device 14 communicates with the management server 4 via the network.

The storage device 15 stores programs to be executed by the processor that constitutes the controller 16 and the like.

The controller 16 includes a face image acquirer 21, a card image acquirer 22, a registration requester 23, and a GUI controller 24. This controller 16 is constituted of a processor, and the processor executes the programs stored in the storage device 15 to realize various components of the controller 16.

The face image acquirer 21 cuts out a face region from the image captured by the face image capturing camera 11 (face cut-out) thereby to acquire a face image (face image for registration) of the target person.

The card image acquirer 22 cuts out a region of the personal identification card from the image captured by the card image capturing camera 12 to acquire a card image.

The registration requester 23 transmits a request for user registration to the management server 4 from the communication device 14. The request for user registration includes the face image and the card image of the target person.

The GUI controller 24 displays a screen related to user registration, which is delivered from the management server 4, on the display 13. Also, according to an input operation of the user using an input function of the display 13 (here, a touch panel), the GUI controller 24 acquires input information and performs screen control.

Note that it is possible to determine whether the face image acquired by the face image acquirer 21 is appropriate and, when the face image is not appropriate, to make the display 13 display a screen prompting the user to capture an image again.

Also, the registration machine 5 may be configured such that a cradle for reading the information held by each battery pack 2 can be connected thereto. In this case, at the time of user registration, the battery pack 2 to be rented to the user first may be placed on the cradle so that the identification number (individual identification information) and the model number (model identification information) of the battery pack 2 can be read.

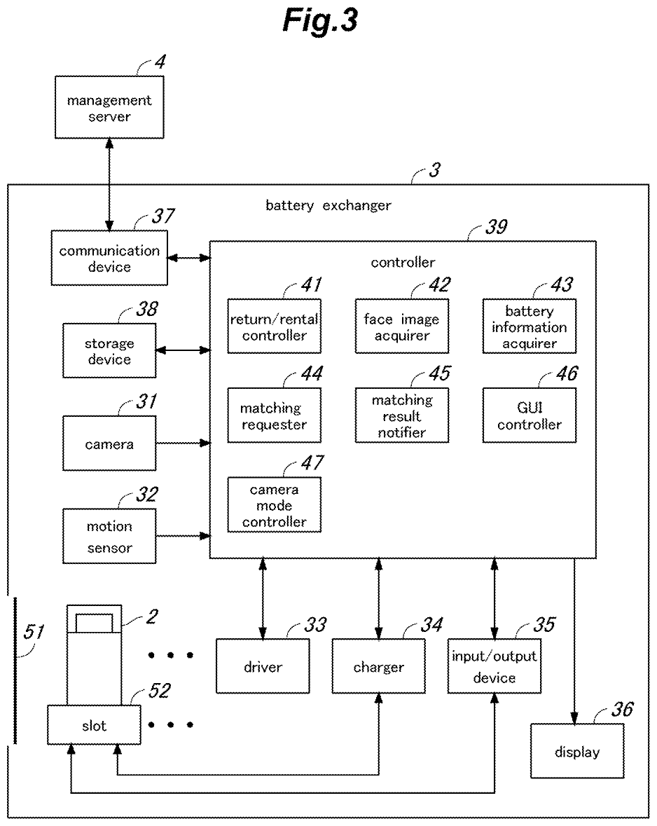

Next, description will be made of a schematic configuration of the battery exchanger 3 regarding the first embodiment. FIG. 3 is a block diagram showing a schematic configuration of the battery exchanger 3.

The battery exchanger 3 includes a camera 31, a motion sensor 32, a driver 33, a charger 34, an input/output device 35, a display 36, a communication device 37, a storage device 38, and a controller 39.

The camera 31 captures an image of a person (visitor) who has visited for battery exchange. Note that to reliably acquire the face image of the visitor, multiple cameras 11 may be arranged in the vertical direction to acquire the face image corresponding to the height of the visitor.

The motion sensor 32 detects that a person has come near the battery exchanger 3.

In response to an instruction from the controller 39, the driver 33 drives, upon return or rental of the battery packs 2, an opening/closing mechanism of a shutter 51 (opening/closing door) provided at an opening for putting in and out the battery packs 2 and a storing/dispensing mechanism for storing the returned battery packs 2 and dispensing the battery packs 2 to be rented to the users.

The charger 34 charges the battery packs 2 via slots 52 (trays).

The input/output device 35 transmits and receives information to and from the battery packs 2. For example, the model numbers, alerts, deterioration information on the battery packs 2 are received from the battery packs 2.

The display 36 displays a guidance screen related to exchange of the battery packs 2.

The communication device 37 communicates with the management server 4 via the network.

The storage device 38 stores programs to be executed by a processor that constitutes the controller 19 and the like.

The controller 39 includes a return/rental controller 41, a face image acquirer 42, a battery information acquirer 43, a matching requester 44, a matching result notifier 45, a GUI controller 46, and a camera mode controller 47. This controller 39 is constituted of a processor, and the processor executes the programs stored in the storage device 38 to realize the various components of the controller 39.

The return/rental controller 41 controls operations of return and rental of the battery packs 2. Specifically, when an approach of a person is detected by the motion sensor 32, the return/rental controller 41 controls the driver 33 to move vacant slots 52 to the opening for putting in and out the battery packs and to open the shutter 51 so that the user can return the battery packs 2. Also, when an exchange permission notification is received from the management server 4, the return/rental controller 41 controls the driver 33 to move the slots 52 in which the charged battery packs 2 to be rented to the user are set to the opening for putting in and out the battery packs and open the shutter 51 so that the user can receive the battery packs 2 to be rented to the user.

The face image acquirer 42 detects a face of a person from the image captured by the camera 31 (face detection) and cuts out a face region from the captured image (face cut-out) thereby to acquire the face image (face image for authentication) of the target person.

The battery information acquirer 43 acquires the model number (model identification information) from each returned battery pack 2 via the input/output device 35.

The matching requester 44 transmits a request for face matching and battery matching to the management server 4 from the communication device 37. The request for face matching and battery matching includes the face image of the visitor and the model number of each battery pack 2.

The matching result notifier 45 causes the matching result acquired from the management server 4 via the communication device 37 to be displayed on the display 36 thereby to notify the matching result, namely, whether the battery exchange may be permitted, to the user.

The GUI controller 46 a screen related to the face authentication and the battery exchange delivered from the management server 4 to be displayed on the display 36. Also, in response to the user's input operation using an input function of the display 36 (here, a touch panel), the GUI controller 46 acquires input information and performs screen control.

The camera mode controller 47 switches an operation mode related to the processing of the images captured by the camera 31 between a face authentication mode and a security monitoring mode. Specifically, the camera mode controller 47 usually operates in the face authentication mode, and upon failure of face authentication, transitions from the face authentication mode to the security monitoring mode. In the security monitoring mode, the camera mode controller 47 uploads the images captured by the camera 31 to the management server 4 as monitoring images. In the management server 4, the monitoring images uploaded from the battery exchanger 3 are accumulated. Thereby, it is possible to check the behavior of a suspicious person at a later time.

Note that the battery exchanger 3 may cause the images captured by the camera 31 to be accumulated in the storage device 38 as monitoring images. Also, failure of face authentication may occur not only when the face matching fails, namely, when the comparison of the face image acquired from the battery exchanger 3 with the face images registered in the management server 4 results in no matching user, but also when the face image does not meet predetermined quality due to wearable items (masks and sunglasses) of target person and the like. Also, when a wearable item of target person is detected, a guidance (voice, display) prompting removal of the wearable item may be output, and when the target person does not follow the guidance, the camera 31 may be caused to transition to the security monitoring mode.

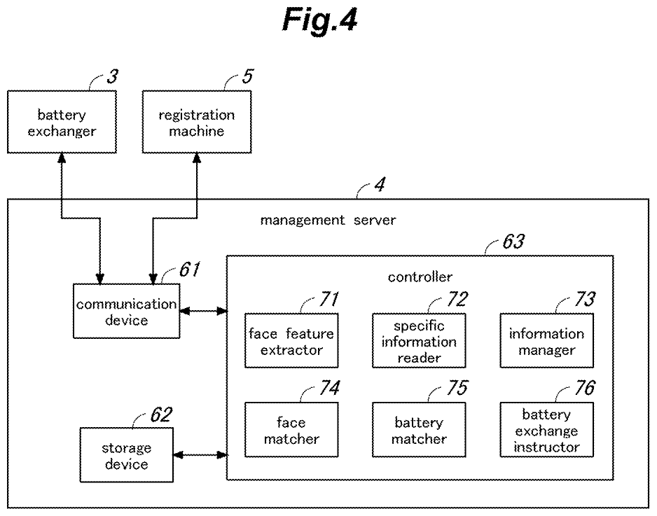

Next, description will be made of a schematic configuration of the management server 4 regarding the first embodiment. FIG. 4 is a block diagram showing a schematic configuration of the management server 4.

The management server 4 includes a communication device 61, a storage device 62, and a controller 63.

The communication device 61 communicates with the battery exchanger 3 and the registration machine 5 via the network.

The storage device 62 stores registration information of a user management table (user management information), programs to be executed by the processor that constitutes the controller 63, and the like.

The controller 63 includes a face feature extractor 71, a specific information reader 72, an information manager 73, a face matcher 74, a battery matcher 75, and a battery exchange instructor 76. This controller 63 is constituted of a processor, and the processor executes the programs stored in the storage device 62 to realize the various components of the controller 63.

The face feature extractor 71 extracts, at the time of user registration, face feature information from the face image of the target person of the user registration acquired from the registration machine 5. Also, at the time of battery exchange, the face feature extractor 71 extracts face feature information from the face image of the visitor acquired from the battery exchanger 3.

The specific information reader 72 reads, at the time of user registration, letters and symbols contained on the face of the personal identification card by OCR (optical character recognition) processing performed on the card image acquired from the registration machine 5, thereby to acquire the specific information of the target person.

The information manager 73 registers, at the time of user registration, the face feature information of the target person acquired by the face feature extractor 71 and the specific information of the target person acquired by the specific information reader 72 in the user management table.

The face matcher 74 performs, at the time of battery exchange, face matching to determine whether the visitor is a legitimate user by comparing the face feature information of the visitor acquired by the face feature extractor 71 with the pieces of face feature information registered in the user management table. Note that a face image of a user is acquired every time the battery exchange is performed, and therefore, the face feature information extracted from this face image may be used to update the pieces of face feature information of the users registered in the user management table.

The battery matcher 75 performs battery matching to determine whether the battery packs 2 returned by the user to the battery exchanger 3 are batteries covered by the battery exchange service.

The battery exchange instructor 76 determines whether the battery exchange may be permitted and notifies the determination result, namely, whether the battery exchange may be permitted, to the battery exchanger 3. Specifically, if the face matcher 74 determines that the visitor is a legitimate user and the battery matcher 75 determines that the battery packs 2 returned by the user are batteries covered by the battery exchange service, an exchange permission notification that permits the battery exchange is transmitted from the communication device 61 to the battery exchanger 3. Also, in a case where it is determined that the visitor is not a legitimate user or the battery packs 2 returned by the user are different from the battery packs 2 being rented to the user, an exchange non-permission notification that does not permit the battery exchange is transmitted from the communication device 61 to the battery exchanger 3.

Note that in the present embodiment, the face feature extractor 71 is provided in the management server 4 but it is possible to provide the face feature extractor in the registration machine 5 and to forward the face feature information extracted from the face image of the target person to the management server 4. It is also possible to provide the face feature extractor in the battery exchanger 3 and to forward the face feature information extracted from the face image of the visitor to the management server 4.

Further, in the present embodiment, the specific information reader 72 is provided in the management server 4 but it is possible to provided the specific information reader in the registration machine 5 and to forward the specific information acquired via OCR processing performed on the card image to the management server 4. It is also possible to provide the face feature extractor 71 in the battery exchanger 3 and to forward the face feature information extracted from the face image of the target person to the management server 4.

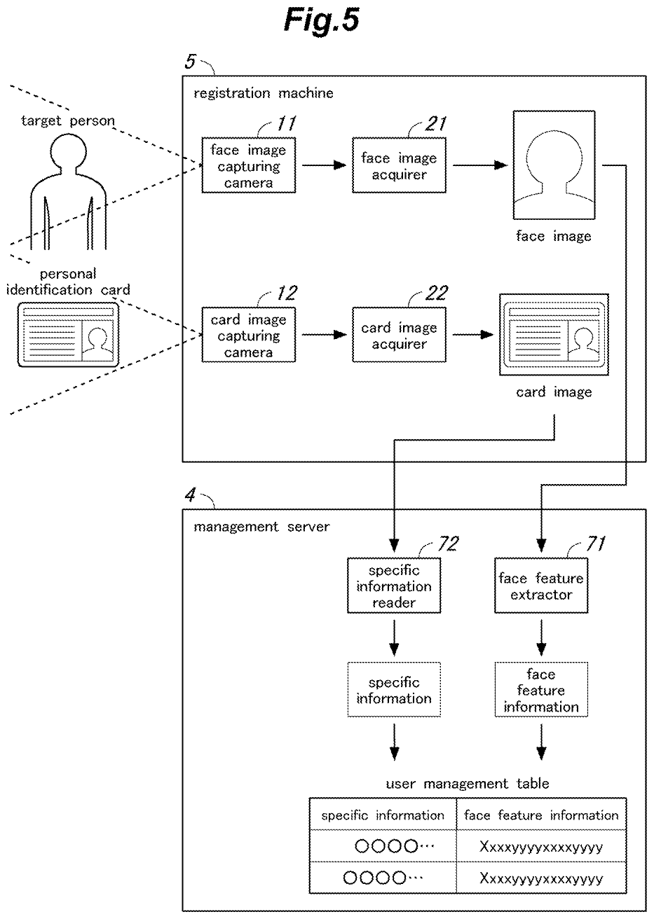

Next, description will be made of a process performed by the registration machine 5 and the management server 4 regarding the first embodiment at the time of user registration. FIG. 5 is an explanatory diagram showing an outline of the process performed by the registration machine 5 and the management server 4 at the time of user registration.

In the present embodiment, when subscribing to the battery exchange service to start using the battery packs 2, the target person or a staff member performs an operation of user registration at the registration machine 5. At this time, in the registration machine 5, the face image capturing camera 31 captures an image of the face of the target person, and the face image acquirer 21 cuts out an image region of the face from the image captured by the face image capturing camera 31 to acquire the face image of the target person.

In addition, in the registration machine 5, the card image capturing camera 12 captures an image of the personal identification card of the target person; specifically, a driver's license, a membership card of the battery exchange service (member's card), or the like, and the card image acquirer 22 cuts out an image region of the personal identification card from the image captured by the card image capturing camera 12 to acquire a card image. Then, the face image of the target person and the card image of the target person are transmitted from the registration machine 5 to the management server 4.

In the management server 4, the face feature extractor 71 extracts the face feature information of the target person from the face image of the target person. Also, in the management server 4, the specific information reader 72 extracts the specific information (user information) of the target person from the card image by OCR processing. Then, the face feature information of the target person and the specific information of the target person are registered in the user management table.

Here, the specific information is information that is provided on the face of the personal identification card other than the face image and that is used to specify the user; specifically, the name (user name), address, and the like. Also, of the information provided on the face of the personal identification card, information not directly related to specifying of an individual may be acquired as auxiliary specific information (addition information). Note that in a case where the personal identification card is a driver's license, the name (user name), address, license type, license number, expiration date, and the like are acquired as the specific information. Also, in a case where the personal identification card is a membership card of the battery exchange service (member's card), the name (user name), address, membership number, expiration date, and the like are acquired as the specific information.

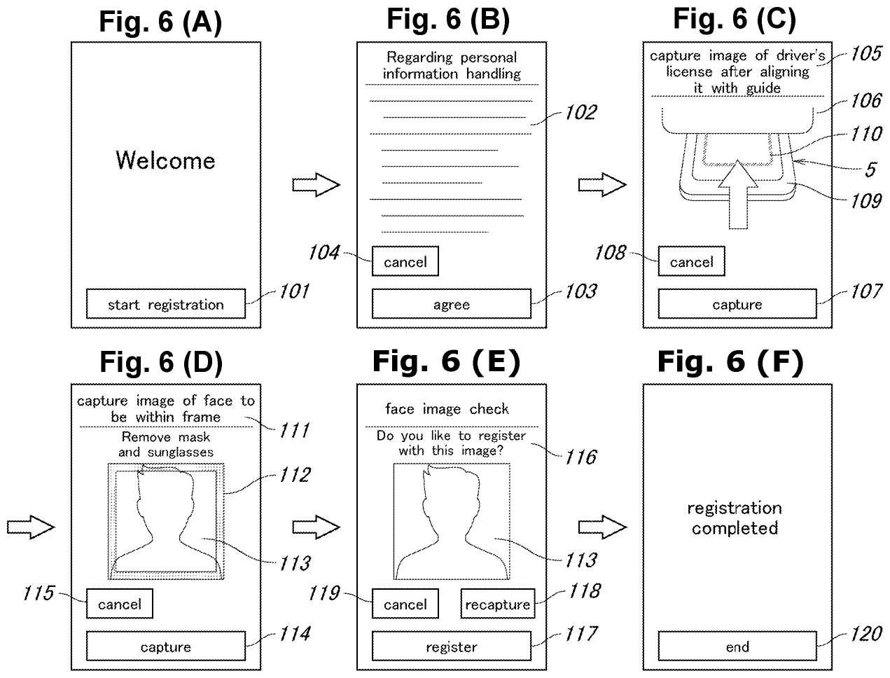

Next, description will be made of an operation performed at the registration machine 5 regarding the first embodiment at the time of user registration. FIG. 6 is an explanatory diagram showing a screen displayed on the display 13 of the registration machine 5 at the time of user registration. Note that here, description will be made of a case where the target person of user registration her/himself performs screen operation, but the screen operation may be performed by a staff member for user registration.

On the display 13 of the registration machine 5, first, an initial screen shown in FIG. 6(A) is displayed. A registration start button 101 is provided in this initial screen (see FIG. 6(A)). When the target person operates this registration start button 101, the screen transitions to a personal information handling rule confirmation screen shown in FIG. 6(B).

In the personal information handling rule confirmation screen (see FIG. 6(B)), a text 102 representing personal information handling rules for the face authentication system is displayed. Also, this screen is provided with an agree button 103 and a cancel button 104. The target person operates the agree button 103 or the cancel button 104 according to whether the target person agrees to the personal information handling rules. When the target person operates the agree button 103, the screen transitions to a personal identification card image capturing screen shown in FIG. 6(C). When the target person operates the cancel button 104, the user registration is cancelled.

In the personal identification card image capturing screen (see FIG. 6(C)), a text 105 describing how to capture an image of the personal identification card and an image 106 illustrating how to capture an image of the personal identification card are displayed. Also, this screen is provided with a capture button 107 and a cancel button 108. When the target person places the personal identification card on a capturing table 109 and operates the capture button 107 by following the image 106, image capture of the personal identification card by the card image capturing camera 12 of the registration machine 5 is executed. At this time, the target person places the personal identification card to align with a guide 110 drawn on the capturing table 109 of the registration machine 5. When the target person operates the cancel button 108, the user registration is cancelled. When the image capture of the personal identification card by the card image capturing camera 12 finishes normally, the screen transitions to a face image capturing screen shown in FIG. 6(D).

In the face image capturing screen (see FIG. 6(D)), a text 111 describing how to capturing the face image, an image capture frame 112, and a captured image 113 are displayed. The captured image 113 is an image captured by the face image capturing camera 11 and is displayed in the image capture frame 112. The target person views the captured image 113 displayed in the image capture frame 112 and adjusts the position and direction of the face so that the image of the face of the target person is properly captured. Also, this screen is provided with a capture button 114 and a cancel button 115. When the target person operates the capture button 114, image capture of the target person by the face image capturing camera 11 of the registration machine 5 is executed. When the target person operates the cancel button 115, the user registration is cancelled. When the capture of the face image by the face image capturing camera 11 finishes normally, the screen transitions to a face image check screen shown in FIG. 6(E).

In the face image check screen (see FIG. 6(E)), a text 116 prompting to confirm whether the face image is properly captured and the captured image (face image) 113 are displayed. Also, this screen is provided with a registration button 117, a recapture button 118, and a cancel button 119. When the image of the face of the target person is properly captured, the target person operates the registration button 117. In this case, the screen transitions to a registration completion screen shown in FIG. 6(F). When the image of the face of the target person is not properly captured, the target person operates the recapture button 118. In this case, the screen returns to the face image capturing screen (see FIG. 6(D)). When the target person operates the cancel button 119, the user registration is cancelled.

The registration completion screen (see FIG. 6(F)) is provided with an end button 120. When the user operates the end button 120, the registration operation at the registration machine 5 ends.

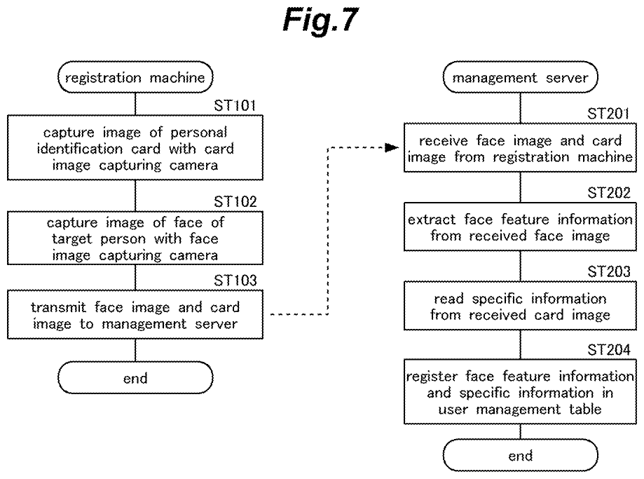

Next, description will be made of an operating procedure of the registration machine 5 and the management server 4 regarding the first embodiment at the time of user registration. FIG. 7 is a flowchart showing an operating procedure of the registration machine 5 and the management server 4 at the time of user registration.

In the registration machine 5, first, an image of the personal identification card (driver's license, etc.) presented by the target person of the user registration is captured by the card image capturing camera 12 to acquire the card image of the target person (ST101). Also, an image of the face of the target person is captured by the face image capturing camera 31 to acquire the face image of the target person (ST102). Then, the face image and the card image of the target person are transmitted to the management server 4 (ST103).

In the management server 4, when the face image and the card image of the target person transmitted from the registration machine 5 are received (ST201), the face feature extractor 71 extracts the face feature information of the target person from the received face image (ST202). Also, the specific information reader 72 acquires the specific information of the target person contained on the face of the personal identification card by OCR processing performed on the received card image (ST203). Then, the information manager 73 registers the face feature information of the target person acquired by the face feature extractor 71 and the specific information of the target person acquired by the specific information reader 72 in the user management table (ST204).

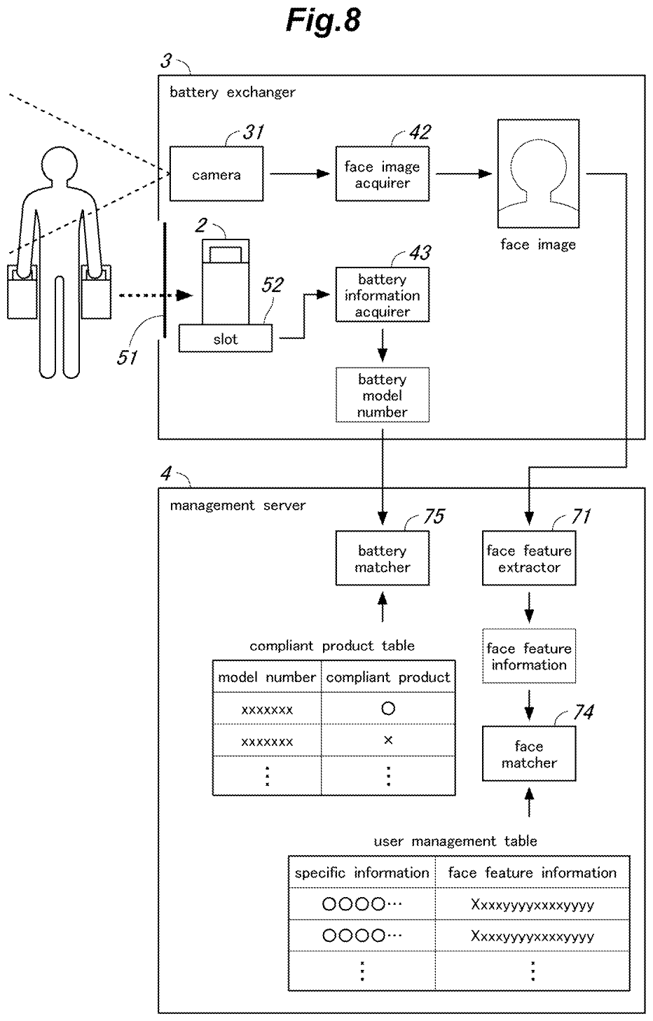

Next, description will be made of a process performed by the battery exchanger 3 and the management server 4 regarding the first embodiment at the time of battery exchange. FIG. 8 is an explanatory diagram showing an outline of a process performed by the battery exchanger 3 and the management server 4 at the time of battery exchange.

In the battery exchanger 3, an image of the face of a person who has visited the battery station (visitor) is captured by the camera 11 to acquire the face image of the visitor. Also, in the battery exchanger 3, the shutter 51 is opened to store the battery packs 2 brought in by the visitor, and the model numbers of the battery packs 2 are read via the slots 52 in which the battery packs 2 are set. Then, the face image of the visitor and the model number of each battery pack 2 are transmitted to the management server 4.

In the management server 4, the face feature extractor 71 extracts the face feature information from the received face image of the visitor. Also, the face matcher 74 compares the face feature information of the visitor with the pieces of face feature information registered in the user management table to determine whether the visitor is a legitimate user. At this time, it is determined that the visitor is a legitimate user when a piece of face feature information similar to the face feature information of the visitor is included in the pieces of face feature information registered in the user management table.

Also, in the management server 4, the battery matcher 75 determines whether the battery packs 2 returned by the user to the battery exchanger 3 are batteries covered by the battery exchange service based on the received model numbers (model identification information) of the battery packs 2 and a compliant product table which prescribes whether each model number represents batteries covered by the battery exchange service (compliant products).

Here, batteries covered by the battery exchange service may include not only genuine batteries manufactured by electric vehicle makers, but also compatible batteries or rebuilt batteries (recycled batteries) manufactured by battery makers or the like.

Note that it is also possible to acquire the identification number (individual identification information) of each battery pack 2 and to determine whether the battery packs 2 returned to the battery exchanger 3 by the user are the same as the battery packs 2 being rented to the user.

Here, the management server 4 permits the battery exchange when it is determined that the visitor is a legitimate user and it is determined that the battery packs 2 returned by the user are batteries covered by the battery exchange service.

Note that in the present embodiment, the face image is extracted from the captured image of the user at the battery exchanger 3 and the face image is transmitted to the management server 4. The transmission data may include only data of the image of the face region, but the transmission data may also be a combination of data of the captured image (the image in a predetermined image capture area) and the position information of the face region (face frame information) on the data of the captured image.

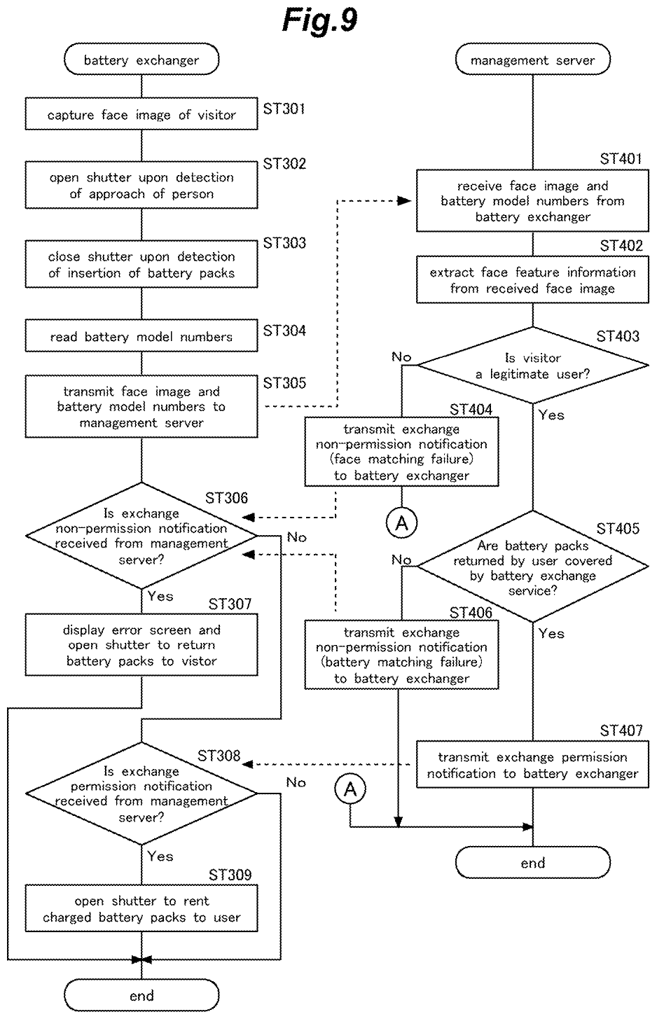

Next, description will be made of an operating procedure of the battery exchanger 3 and the management server 4 regarding the first embodiment at the time of battery exchange. FIG. 9 is a flowchart showing an operating procedure of the battery exchanger 3 and the management server 4 at the time of battery exchange.

In the battery exchanger 3, first, an image of a visitor is captured by the camera 11 to acquire the face image of the visitor (ST301). Then, when the motion sensor 32 detects the person (visitor) approaching the own device (Yes in ST403), the shutter 51 is opened (ST302). Thereby, the visitor can return the battery packs 2 to the battery exchanger 3.

Then, upon detection of the return of the battery packs 2, the shutter 51 is closed (ST303). Subsequently, the model number of each battery pack 2 is read (ST304). Next, the face image of the visitor and the model numbers of the battery packs 2 are transmitted from the communication device 37 to the management server 4 (ST305). Note that it is possible to transmit the face image of the visitor and the model numbers of the battery packs 2 to the management server 4 without closing the shutter 51, and in this case, if it is determined that the battery exchange is not permitted, a message to remove the battery pack 2 may be displayed to notify it to the user.

In the management server 4, when the face image of the visitor and the model numbers of the battery packs 2 transmitted from the battery exchanger 3 are received by the communication device 61 (ST401), first, the face feature extractor 71 extracts the face feature information of the visitor from the received face image (ST402).

Then, the face matcher 74 compares the face feature information of the visitor with the pieces of face feature information registered in the user management table to determine whether the visitor is a legitimate user (ST403).

Here, when the visitor is not a legitimate user (No in ST403), the exchange non-permission notification is transmitted from the communication device 61 to the battery exchanger 3 (ST404). At this time, failure of the face matching, namely, information indicating that the visitor is not a legitimate user is added to the exchange non-permission notification.

On the other hand, when the visitor is a legitimate user (Yes in ST403), then, the battery matcher 75 determines whether the battery packs 2 returned by the user to the battery exchanger 3 are batteries covered by the battery exchange service (ST405).

Here, when the battery packs 2 returned by the user are not batteries covered by the battery exchange service (No in ST405), the exchange non-permission notification is transmitted from the communication device 61 to the battery exchanger 3 (ST406). At this time, failure of the battery matching, namely, information indicating that the user attempted fraudulent battery exchange is added to the exchange non-permission notification.

On the other hand, when the battery packs 2 returned by the user are batteries covered by the battery exchange service (Yes in ST405), the exchange permission notification is transmitted from the communication device 61 to the battery exchanger 3 (ST407).

In the battery exchanger 3, when the exchange non-permission notification is received from the management server 4 (Yes in ST306), an error screen for notifying the user that the battery exchange cannot be permitted is displayed on the display 36, and the shutter 51 is opened to return the battery packs 2 brought in by the visitor to the visitor (ST307).

Also, when the exchange permission notification is received from the management server 4 (Yes in ST308), the shutter 51 is opened to rent the charged battery packs 2 to the user (ST309).

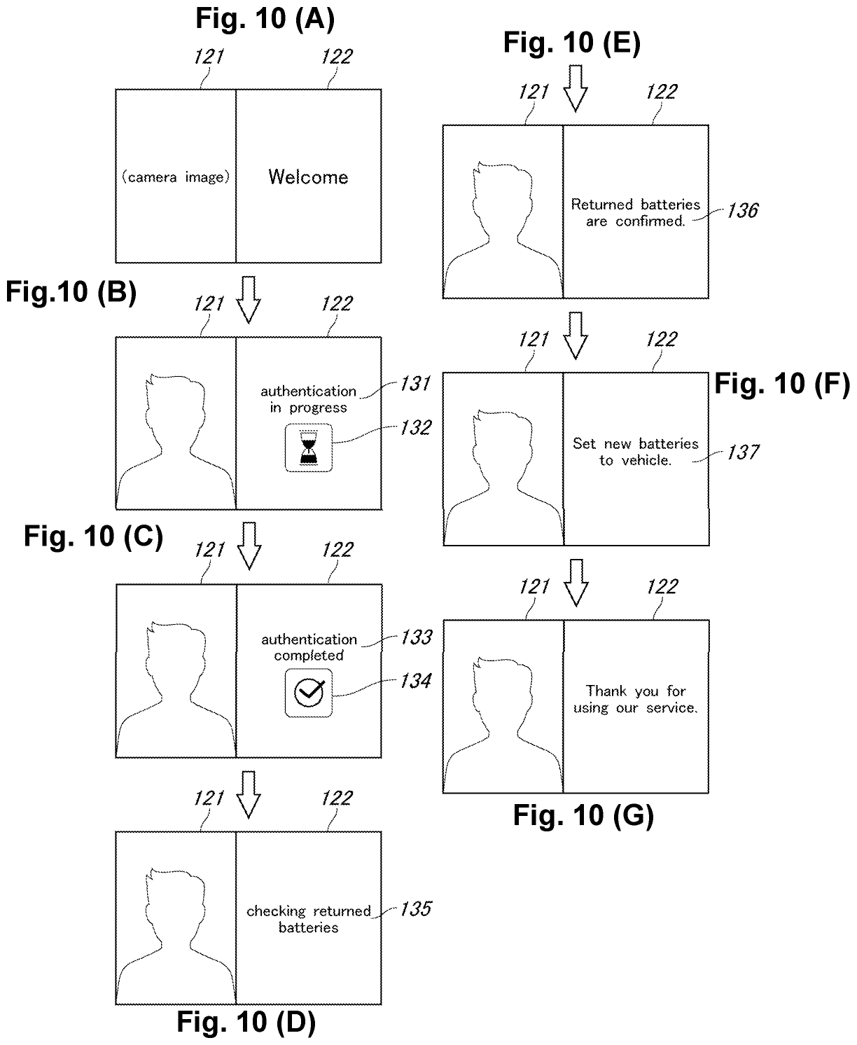

Next, description will be made of a battery exchange operation performed at the battery exchanger 3 regarding the first embodiment. FIG. 10 is an explanatory diagram showing a screen displayed on the display 36 of the battery exchanger 3 at the time of battery exchange.

On the display 36 of the battery exchanger 3, screens shown in FIG. 10(A) to FIG. 10(G) are displayed. These screens are each provided with a captured image display area 121 and an information display area 122. In the captured image display area 121, an image captured by the camera 31 of the battery exchanger 3 is displayed. In the information display area 122, information in accordance with each stage is displayed.

On the display 36 of the battery exchanger 3, first, a stand-by screen (initial screen) shown in FIG. 10(A) is displayed. When an image of a person standing in front of the battery exchanger 3 is captured by the camera 31 of the battery exchanger 3, a process for determining whether the visitor is a legitimate user (face matching) is started in the management server 4. At this time, the screen on the display 36 of the battery exchanger 3 transitions to a face-authentication-in-progress screen shown in FIG. 10(B).

In the face-authentication-in-progress screen (see FIG. 10(B)), a text 131 and a FIG. 132 indicating that the face authentication (face matching) of the user is in progress are displayed in the information display area 122. When the face authentication performed in the management server 4 completes (succeeds), the screen on the display 36 of the battery exchanger 3 transitions to an authentication completion screen shown in FIG. 10(C).

In the face authentication completion screen (see FIG. 10(C)), a text 133 and a FIG. 134 indicating that the face authentication of the user has completed (succeeded) are displayed in the information display area 122. When the face authentication completes (succeeds), a process for determining whether the battery packs 2 returned by the user are batteries covered by the battery exchange service (battery matching) is started in the management server 4. The screen on the display 36 of the battery exchanger 3 transitions to a battery-matching-in-progress screen related to the battery pack 2 shown in FIG. 10(D).

In the battery-matching-in-progress screen (see FIG. 10(D)), a text 135 representing that the returned battery packs 2 are being checked (matching is in progress) is displayed in the information display area 122. When the battery matching process completes (succeeds), the screen on the display 36 of the battery exchanger 3 transitions to a battery matching completion screen shown in FIG. 10(E).

In the battery matching completion screen (see FIG. 10(E)), a text 136 indicating that the battery matching process has completed (succeeded) is displayed in the information display area 122. At this time, in the battery exchanger 3, an operation of opening the shutter 51 to rent the charged battery packs 2 to the user (renting operation) is started. Then, when the renting operation completes, the screen of the display 36 of the battery exchanger 3 transitions to a battery rental screen shown in FIG. 10(F).

In the battery rental screen (see FIG. 10(F)), a text 137 prompting the user to install the charged battery packs 2 to the electric vehicle is displayed. Thereby, the user can take out the charged battery packs 2 from the battery exchanger 3. When the charged battery pack 2 are taken out, the shutter 51 is closed. At this time, the screen of the display 36 of the battery exchanger 3 transitions to a battery exchange completion screen shown in FIG. 10(G).

Note that in the example shown in FIG. 10, the result of the face authentication and the result of the battery matching are displayed on separate screens, and therefore, the notification of the face authentication result and the notification of the battery matching result are separately transmitted from the management server 4 to the battery exchanger 3. However, it is possible to integrate the result of the face authentication and the result of the battery matching so that they are displayed in one screen.

### Second Embodiment

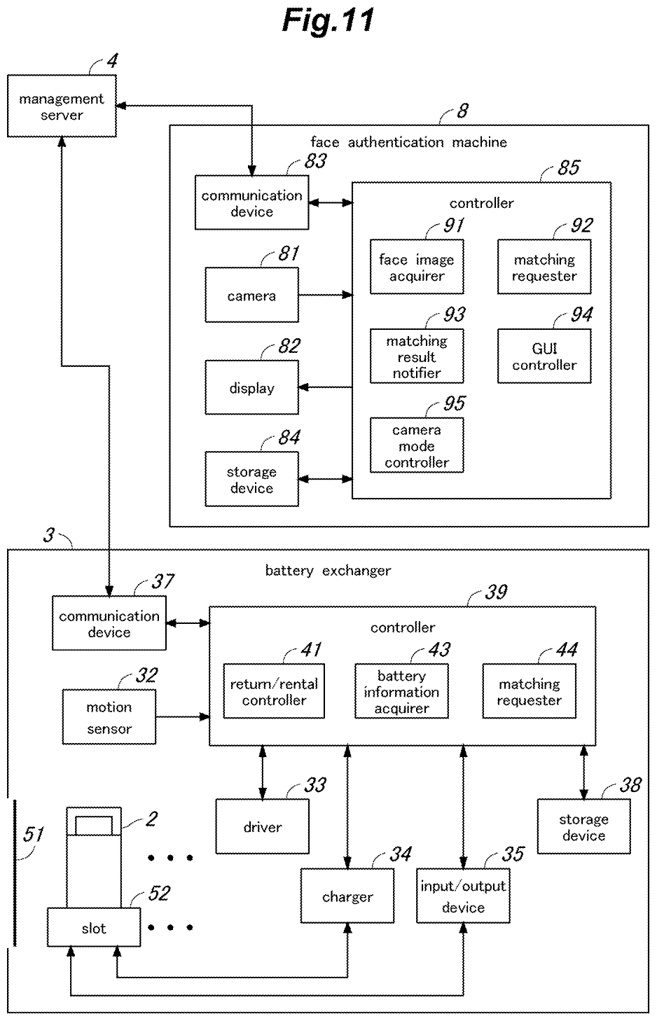

Next, a second embodiment will be described. Note that the features not particularly mentioned here are the same as in the aforementioned embodiment. FIG. 11 is a block diagram showing a schematic configuration of the battery exchanger 3 and a face authentication machine 8 regarding the second embodiment.

In the first embodiment, the battery exchanger 3 was configured to perform the process related to the face authentication, but in the present embodiment, a face authentication machine 8 for performing the process related to the face authentication is provided separately from the battery exchanger 3. In this case, the face authentication machine 8 is installed on the front side of the battery exchanger 3, and the user first comes in front of the face authentication machine 8, and after having undergone face authentication by the face authentication machine 8, moves to the front of the battery exchanger 3 to perform the battery exchange work.

As in the first embodiment (see FIG. 3), the battery exchanger 3 includes the motion sensor 32, the driver 33, the charger 34, the input/output device 35, the communication device 37, the storage device 38, and the controller 39, but the camera 31 and the display 36 are omitted.

Also, as in the first embodiment, the controller 19 includes the return/rental controller 41, the battery information acquirer 43, and the matching requester 44, but the face image acquirer 42, the matching result notifier 45, and the camera mode controller 47 are omitted.

The return/rental controller 41 and the battery information acquirer 43 are the same as in the first embodiment. The matching requester 44 transmits a request for battery matching to the management server 4 from the communication device 37. The request for battery matching includes the model number of each battery pack 2.

The face authentication machine 8 includes a camera 81, a display 82, a communication device 83, a storage device 84, and a controller 8.

The camera 81 captures an image of a person (visitor) who has visited for battery exchange.

The display 82 displays a guidance screen related to exchange of the battery packs 2.

The communication device 83 communicates with the management server 4 via the network.

The storage device 84 stores programs to be executed by the processor constituting the controller 85.

The controller 85 includes a face image acquirer 91, a matching requester 92, a matching result notifier 93, a GUI controller 94, and a camera mode controller 95. This controller 85 is constituted of a processor, and the processor executes the programs stored in the storage device 84 to realize various components of the controller 85.

The face image acquirer 91, the matching result notifier 93, the GUI controller 94, and the camera mode controller 95 are the same as the face image acquirer 42, the matching result notifier 45, the GUI controller 46, and the camera mode controller 47 provided in the battery exchanger 3 in the first embodiment. The matching requester 92 transmits a request for face matching to the management server 4 from the communication device 83. This request for face matching includes the face image of the visitor.

Note that the battery exchanger 3 and the face authentication machine 8 may be provided with an interface that enables direct exchange of required information between the battery exchanger 3 and the face authentication machine 8.

### Third Embodiment

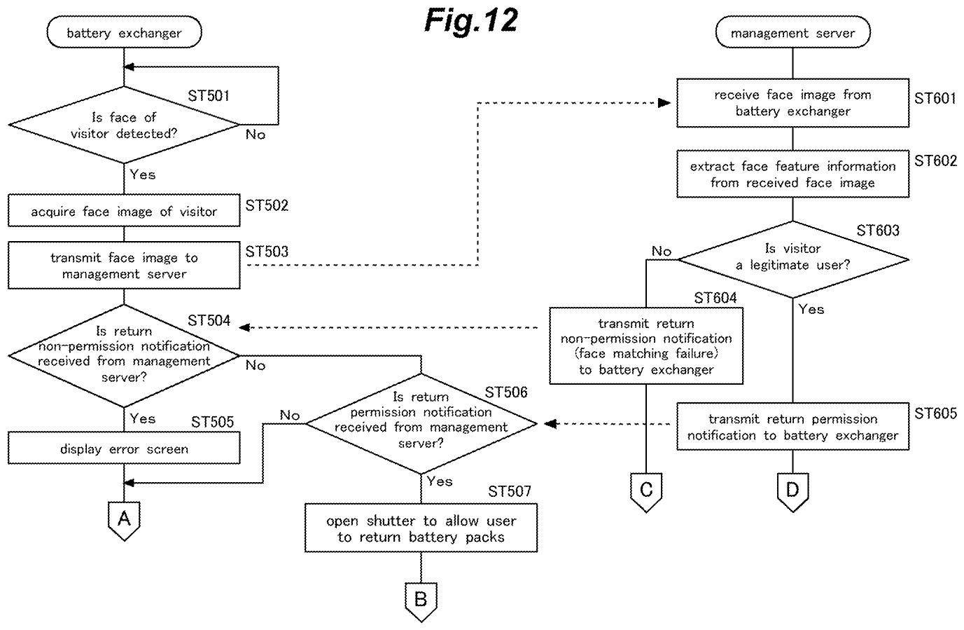

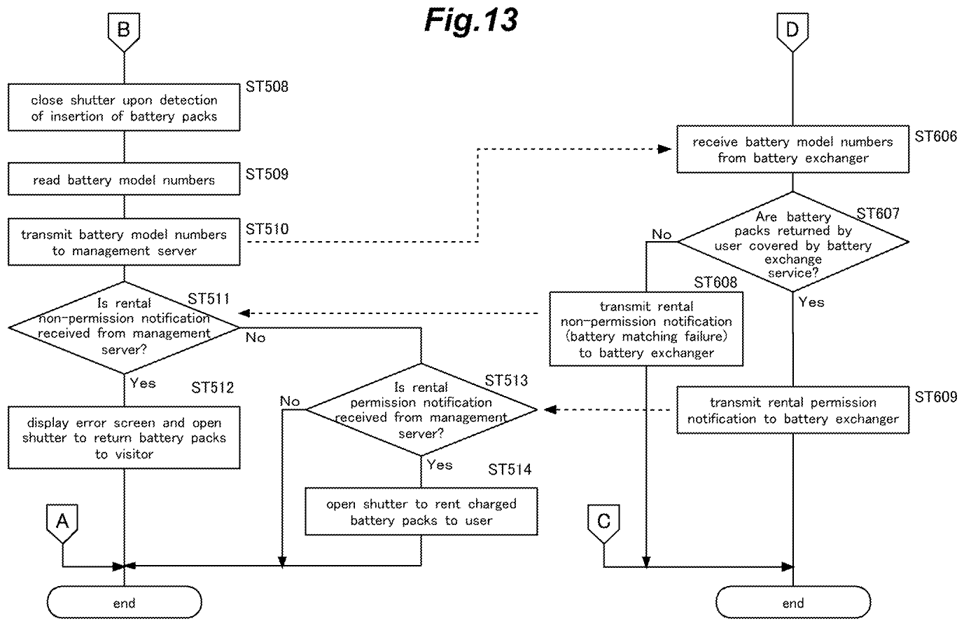

Next, a third embodiment will be described. Note that the features not particularly mentioned here are the same as in the aforementioned embodiment. FIGS. 12 and 13 are a flowchart showing an operating procedure of the battery exchanger 3 and the management server 4 regarding the third embodiment at the time of battery exchange.

In the aforementioned embodiment, the battery exchanger 3 is provided with the motion sensor 32 so that when the motion sensor 32 detects a person who has visited for battery exchange (a visitor), the shutter 51 is opened to allow the visitor to return the battery packs 2 to the battery exchanger 3. In contrast, in the present embodiment, the motion sensor 32 is omitted, and opening and closing of the shutter 51 is controlled according to the result of face authentication performed based on the face image of the visitor captured by the camera 31. Namely, only when the visitor is a legitimate user, the shutter 51 is opened to allow the visitor to return the battery packs 2 to the battery exchanger 3.

As shown in FIG. 12, in the battery exchanger 3, first, when a face of a visitor (a person who has visited for battery exchange) is detected from the image captured by the camera 31 (Yes in ST501), the face image of the visitor is acquired from the image captured by the camera 31 (ST502). Then, the face image of the visitor is transmitted from the communication device 37 to the management server 4 (ST503).

In the management server 4, when the face image of the visitor transmitted from the battery exchanger 3 is received by the communication device 61 (ST601), the face feature extractor 71 extracts the face feature information of the visitor from the received face image (ST602).

Next, the face matcher 74 compares the face feature information of the visitor with the pieces of face feature information registered in the user management table to determine whether the visitor is a legitimate user (ST603).

Here, when the visitor is not a legitimate user (No in ST603), a return non-permission notification is transmitted from the communication device 61 to the battery exchanger 3 (ST604).

On the other hand, when the visitor is a legitimate user (Yes in ST603), a return permission notification is transmitted from the communication device 61 to the battery exchanger 3 (ST605).

In the battery exchanger 3, when the return non-permission notification is received from the management server 4 (Yes in ST504), an error screen for notifying the user that the battery exchange cannot be permitted is displayed on the display 36 (ST505).

Also, when the return permission notification is received from the management server 4 (Yes in ST506), the shutter 51 is opened (ST507). Thereby, the visitor can return the battery packs 2 to the battery exchanger 3.

Then, as shown in FIG. 13, in the battery exchanger 3, the shutter 51 is closed in response to detection of return of the battery packs 2 (ST508). Subsequently, the model numbers of the battery packs 2 are read (ST509), and the model numbers of the battery packs 2 are transmitted from the communication device 37 to the management server 4 (ST510).

In the management server 4, when the model numbers of the battery packs 2 transmitted from the battery exchanger 3 are received by the communication device 61 (ST606), the battery matcher 75 determines whether the battery packs 2 returned by the user to the battery exchanger 3 are batteries covered by the battery exchange service based on the received model numbers (ST607).

Here, when the battery packs 2 returned by the user are not batteries covered by the battery exchange service (No in ST607), the rental non-permission notification is transmitted from the communication device 61 to the battery exchanger 3 (ST608).

On the other hand, when the battery packs 2 returned by the user are batteries covered by the battery exchange service (Yes in ST607), the rental permission notification is transmitted from the communication device 61 to the battery exchanger 3 (ST609).

In the battery exchanger 3, when the rental non-permission notification is received from the management server 4 (Yes in ST511), an error screen for notifying the user that the battery exchange cannot be permitted is displayed on the display 36, and the shutter 51 is opened to return the battery packs 2 brought in by the visitor to the visitor (ST512).

Also, when the rental permission notification is received from the management server 4 (Yes in ST513), the shutter 51 is opened to rent the charged battery packs 2 to the user (ST514). Thereby, the visitor can take out the charged battery packs 2 from the battery exchanger 3.

### Fourth Embodiment

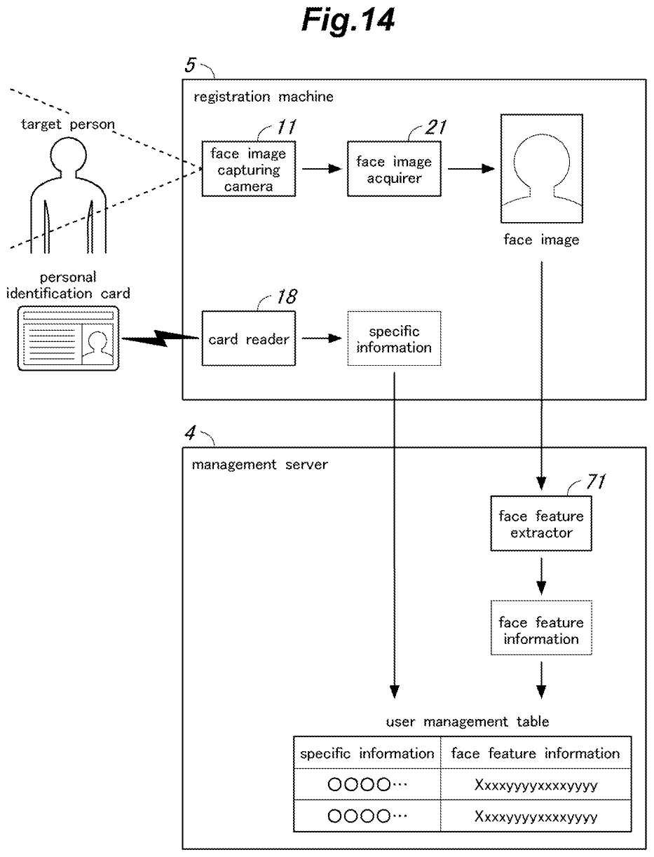

Next, a fourth embodiment will be described. Note that the features not particularly mentioned here are the same as in the aforementioned embodiment. FIG. 14 is an explanatory diagram showing an outline of a process performed by the registration machine 5 and the management server 4 regarding the fourth embodiment at the time of user registration.

In the first embodiment (FIG. 5), at the time of user registration, in the registration machine 5, the card image capturing camera 12 captures an image of the face of the personal identification card presented by the target person and the card image acquirer 22 acquires a card image including the face of the personal identification card, while in the management server 4, the specific information reader 72 reads the letters contained on the face of the personal identification card by OCR processing, thereby to acquire the specific information of the target person.

On the other hand, in the present embodiment, an IC card type personal identification card is used. The specific information is stored in an IC chip of this IC card type personal identification card.

The registration machine 5 is provided with a card reader 18 (information reader) instead of the card image capturing camera 12 in the first embodiment (FIG. 5). The card reader 18 reads the IC card type personal identification card and acquires the specific information stored in the personal identification card.

Note that the card reader 18 may be of either a contact type or a noncontact type. Also, it is possible to provide a tag reader for reading information on the tag attached to a personal certificate (identification card) by a wireless communication method such as RFID (Radio Frequency Identifier).

### Fifth Embodiment

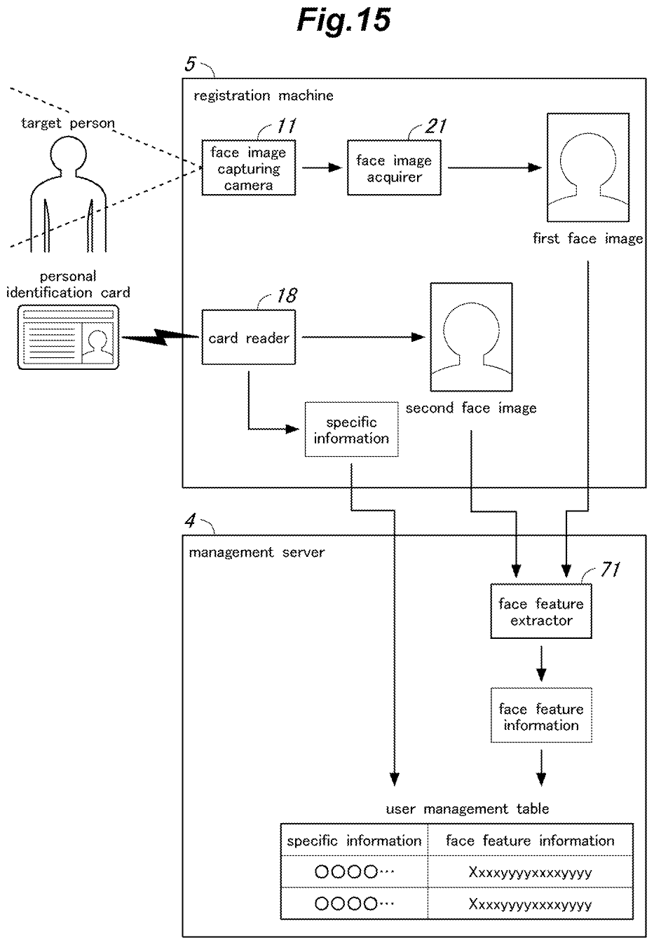

Next, a fifth embodiment will be described. Note that the features not particularly mentioned here are the same as in the aforementioned embodiment. FIG. 15 is an explanatory diagram showing an outline of a process performed by the registration machine 5 and the management server 4 regarding the fifth embodiment at the time of user registration.

In the present embodiment, as in the fourth embodiment, the IC card type personal identification card is used, but in the present embodiment, the face image is stored in the IC chip of the personal identification card other than the specific information.

In the registration machine 5, the card reader 18 reads the personal identification card and acquires the face image (second face image) and the specific information stored in the personal identification card. Also, in the registration machine 5, as in the first embodiment, the face image capturing camera 11 captures an image of the face of the target person, and the face image acquirer 21 acquires the face image of the target person (first face image) from the image captured by the face image capturing camera 31.

In the management server 4, the face feature extractor 71 performs a process of extracting the face feature information from the face image on both of the first face image acquired from the image captured by the face image capturing camera 31 and the second face image acquired from the personal identification card, and registers the face feature information extracted from the first face image and the face feature information extracted from the second face image in the user management table. In this case, in the face authentication at the time of battery exchange, the battery exchange may be permitted if the face authentication succeeds with either one of the first face image and the second face image.

Note that if the face image stored in the IC card type personal identification card is a high resolution image suitable for the face authentication, the face image capturing camera 11 and the face image acquirer 21 may be omitted.

### Sixth Embodiment

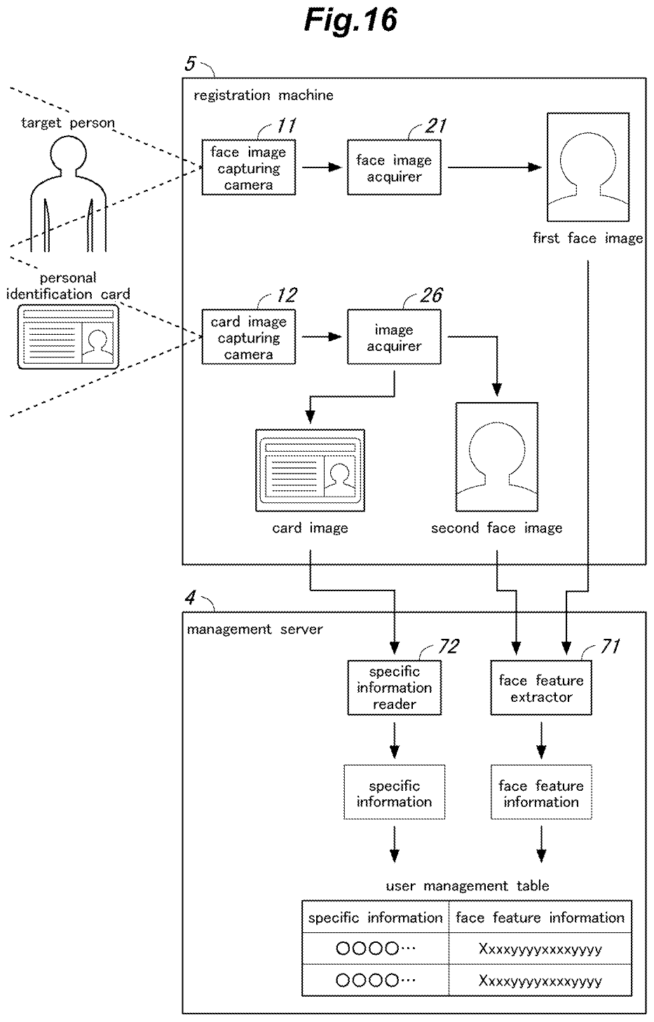

Next, a sixth embodiment will be described. Note that the features not particularly mentioned here are the same as in the aforementioned embodiment. FIG. 16 is an explanatory diagram showing an outline of a process performed by the registration machine 5 and the management server 4 regarding the sixth embodiment at the time of user registration.

In the present embodiment, a personal identification card having a face on which the face image is printed in addition to the specific information is used.

In the registration machine 5, as in the first embodiment, the face image capturing camera 11 captures an image of the face of the target person, and the face image acquirer 21 acquires the face image of the target person (first face image) from the image captured by the face image capturing camera 31. Also, in the registration machine 5, the card image capturing camera 12 captures an image of the face of the personal identification card, and an image acquirer 26 cuts out a region of the personal identification card from the image captured by the camera 12 to acquire the card image. Also, the image acquirer 26 cuts out a region of the face image from the image captured by the camera 12 to acquire the face image (second face image).

In the management server 4, the face feature extractor 71 extracts the face feature information from each of the first face image and the second face image acquired from the registration machine 5 and registers the face feature information in the user management table. Also, the specific information reader 72 extracts the specific information (user information) of the target person from the card image by OCR processing.

In the foregoing, description was made of embodiments to illustrate the technology disclosed in the present application. However, the technology of the present disclosure is not limited to them and may be applied to embodiments which may include change, replacement, addition, omission, etc. Also, new embodiments may be made by combining the components described with respect to the above embodiments.

### INDUSTRIAL APPLICABILITY

The battery management system and the battery management method according to the present disclosure can reduce the user's labor at the time of battery exchange and ensure sufficient security regarding the user authentication, and are useful as a battery management system and a battery management method for managing exchange of battery devices by users in a battery exchange service in which users of electric vehicles or the like exchange battery devices at battery stations.

### LIST OF REFERENCE NUMERALS

1 electric vehicle
2 battery pack (battery device)
3 battery exchanger (battery exchange device)
4 management server (server device)
5 registration machine (registration device)
8 face authentication machine
11 face image capturing camera
12 card image capturing camera
13 display
14 communication device
15 storage device
16 controller
18 card reader
19 controller
31 camera
32 motion sensor
33 driver
34 charger
35 input/output device
36 display
37 communication device
38 storage device
39 controller
51 shutter
52 slot
61 communication device
62 storage device
63 controller

1. A battery management system, comprising:
multiple battery devices shared in a battery exchange service;
a battery exchange device configured to store and charge the battery devices and to rent the charged battery devices to users;
a server device connected to the battery exchange device via a network and configured to manage battery exchange at the battery exchange device; and
a registration device configured to acquire face images for registration used in face authentication of the users,
wherein the registration device acquires the face images for registration and specific information which is information other than the face images and is used to specify the users, and
the server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.

2. The battery management system according to claim 1, wherein the battery exchange device is provided with a camera for capturing an image of the person who has visited for battery exchange, and
the face image for authentication is acquired from an image captured by the camera.

3. The battery management system according to claim 1, wherein the registration device acquires the specific information from personal identification cards presented by the users.

4. The battery management system according to claim 3, wherein the personal identification cards are each an IC card, and
the registration device acquires information stored in the personal identification cards as the specific information.

5. The battery management system according to claim 1, wherein the registration device acquires the face images for registration from personal identification cards presented by the users.

6. The battery management system according to claim 5, wherein the personal identification cards are each an IC card, and
the registration device acquires face images stored in the personal identification cards as the face images for registration.

7. The battery management system according to claim 3, wherein each personal identification card is either a driver's license or a membership card of the battery exchange service.

8. The battery management system according to claim 1, wherein the battery exchange device has a shutter at an opening for putting in and out the battery devices, and controls opening and closing of the shutter according to a result of determination by the server device on whether to permit the battery exchange.

9. A battery management method for managing exchange of battery devices by users in a battery management system comprising a battery exchange device configured to store and charge the battery devices and to rent the charged battery devices to the users, wherein:
a registration device acquires face images for registration used in face authentication of the users and specific information which is information other than the face images and is used to specify the users; and
a server device acquires the specific information of each user from the registration device to perform user management, compares a face image for authentication acquired from a captured image of a person who has visited for battery exchange with the face images for registration thereby to perform face matching to determine whether the target person is a legitimate user, and determines whether the battery exchange may be permitted based on a result of the face matching.
